(19) United States
(12) Patent Application Publication
(10) Pub. No.: US 2005/0157457 A1
(43) Pub. Date: Jul. 21, 2005

(54) Display apparatus and method of making the same

(76) Inventor: Kwey-hyun Kim, Suwon-si (KR)

Correspondence Address: STANZIONE & KIM, LLP, 1740 N STREET, N.W., FIRST FLOOR, WASHINGTON, DC, 20036, US

(21) Appl. No.: 11/037,147

(22) Filed: Jan. 19, 2005

(30) Foreign Application Priority Data
Jan. 19, 2004 (KR) 2004-3937

(51) Int. Cl. G06F 1/16

(52) U.S. Cl. 361/681

(57) ABSTRACT

A display apparatus including a panel assembly displaying a picture, and a main body supporting the panel assembly on a front side thereof. The main body is formed with an opening on an upper area thereof and a handle provided on a top area thereof and positioned above the opening. The handle and opening provide for the display apparatus to be stably held without being dropped.

### CROSS-REFERENCE TO RELATED APPLICATIONS

This application claims the priority of Korean Patent Application No. 2004-3937, filed Jan. 19, 2004, in the Korean Intellectual Property Office, the disclosure of which is incorporated in its entirety by reference.

### BACKGROUND OF THE INVENTION

1. Field of the Invention

The general inventive concept relates to a display apparatus and a method of making a display apparatus. More particularly, the general inventive concept relates to a display apparatus that can be carried in a stable manner.

2. Description of the Related Art

A known display apparatus generally comprises a monitor, a stand arranged on a predetermined seating surface to support a display main body, and a hinge enabling the monitor to rotate within a predetermined angle.

Such a known display apparatus is used while in a state of being installed in a particular position. As an example, the display apparatus is usually installed on a desk or on a wall. However, since the technology of portable display apparatuses is being actively developed, users may want to carry the display apparatus to a remote location without being constrained by having a battery installed in the display apparatus in order to eliminate the need for a power cable. As an example, Korean patent publication no. 2002-76271 discloses a monitor operated by a battery.

Such a conventional monitor is installed with a liquid crystal display (LCD) arranged on a front side thereof, and a patch antenna for a wireless communication arranged on a bottom portion thereof. A rear side of the monitor is installed with a stand supporting the monitor and a battery driving the monitor, and formed with a handle groove so that the monitor can be easily carried.

However, with such a conventional monitor, when a user attempts to stably carry the monitor, it is inconvenient because the handle groove into which a user's fingers are inserted is situated on the rear side of the monitor.

As a result, users cannot easily carry monitors in a stable manner that weigh over a particular weight because the handle groove formed on the rear side of these monitors can cause an unstable posture when the users grab the monitor and carry it with their fingers inserted in the groove.

Another disadvantage of conventional monitors is that users may have difficulty with wireless communication in an area having weak transmission signals because the patch antenna for allowing wireless communication is installed in a lower portion of the monitor.

### SUMMARY OF THE INVENTION

Accordingly, it is an aspect of the general inventive concept to provide a display apparatus that can be carried in a stable manner.

Additional aspects and advantages of the general inventive concept will be set forth in part in the description which follows and, in part, will be obvious from the description, or may be learned by practice of the invention.

The foregoing and/or other aspects of the general inventive concept can be achieved by providing a display apparatus including a panel assembly that is capable of displaying a picture, a main body to support the panel assembly on a front side thereof and formed with an opening on an upper area thereof; and a handle structure provided on a top area of the main body and can be positioned above the opening.

According to an aspect of the general inventive concept, the handle structure can extend upward from the top area of the main body and can be arranged above the opening.

According to another aspect of the general inventive concept, the main body can include a front casing and a rear casing provided at the front and the rear of the panel assembly, respectively, and a middle casing provided between the panel assembly and the rear casing.

According to another aspect of the general inventive concept, the opening can include a first opening formed on an upper part of the rear casing and a second opening formed on an upper part of the middle casing. The handle structure can include a first handle part extending upward from a top area of the middle casing and positioned above the second opening, and a second handle part coupled to the first handle part and extending upward from the top area of the rear casing and positioned above the first opening.

According to another aspect of the invention, the display apparatus can include a discharging member provided between the front casing and the middle casing, the discharging member being capable of dissipating heat generated from an area inside the main body to an area outside the main body.

According to yet another aspect of the general inventive concept, a wireless antenna capable of transmitting/receiving data can be provided inside the handle structure.

According to yet another aspect of the general inventive concept, the display apparatus can include a battery and a battery installation part that can be depressed on a rear of the main body and can accommodate the battery.

According to still another aspect of the general inventive concept, the display apparatus can further include a locking hole formed on a first side of the battery installation part; and a locking hook provided on the battery and capable of locking with and releasing from the locking hole.

The foregoing and/or other aspects of the general inventive concept may also be achieved by providing a display apparatus that can include a flat panel display assembly including a flat panel display capable of displaying an image and a main housing body arranged to support the flat panel display assembly and including a carrying handle structure extending therefrom. The flat panel display assembly can be supported by the main housing body such that the flat panel display is viewable by a user in a viewing position thereof. The main housing body can include a top side with respect to the viewing position and the carrying handle structure can extend from the top side of the main housing body such that the display apparatus is capable of being securely held and stably carried by the user.

### BRIEF DESCRIPTION OF THE DRAWINGS

These and/or other aspects and advantages of the general inventive concept will become apparent and more readily appreciated from the following description of the embodiments, taken in conjunction with the accompanying drawings of which:

FIG. 1 is a front perspective view of a display apparatus according to an embodiment of the general inventive concept;

FIG. 2 is an exploded perspective view of the display apparatus according to the embodiment of FIG. 1;

FIGS. 3 and 4 are rear perspective views of the display apparatus according to the embodiment of FIG. 1.

### DETAILED DESCRIPTION OF THE PREFERRED EMBODIMENTS

Reference will now be made in detail to the embodiments of the general inventive concept, examples of which are illustrated in the accompanying drawings, wherein like reference numerals refer to like elements throughout. The embodiments are described-below in order to explain the general inventive concept by referring to the figures.

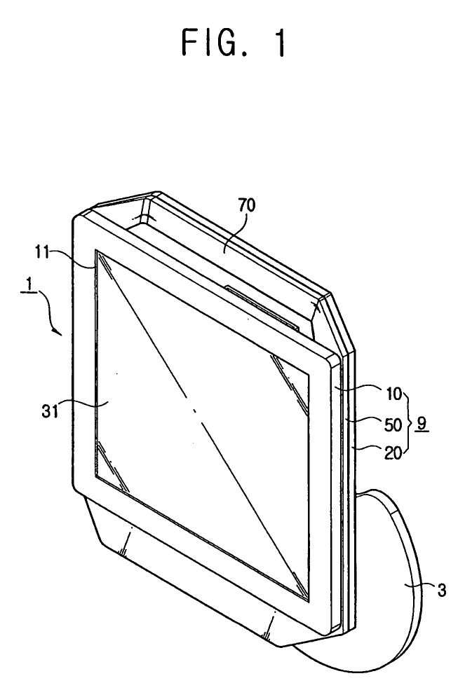

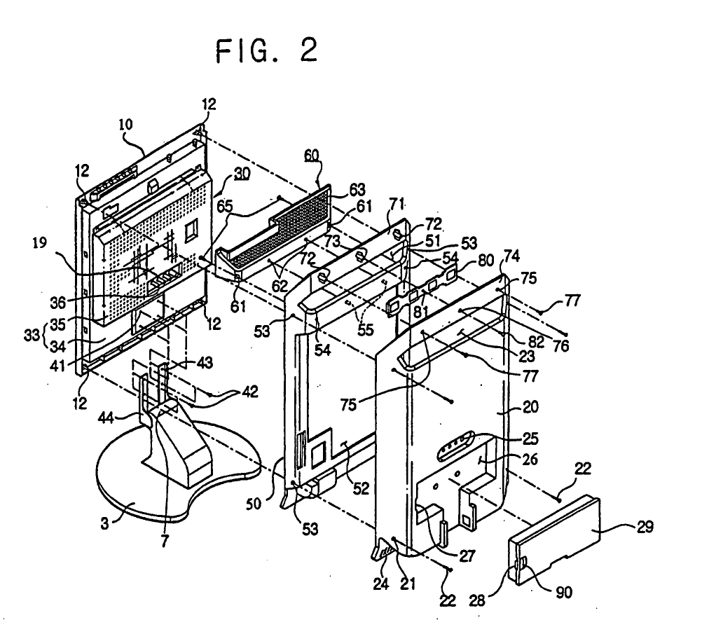

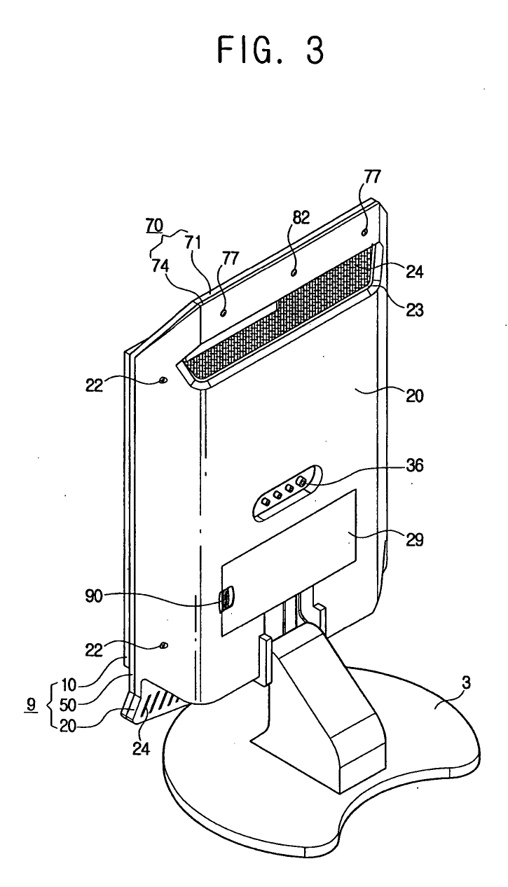

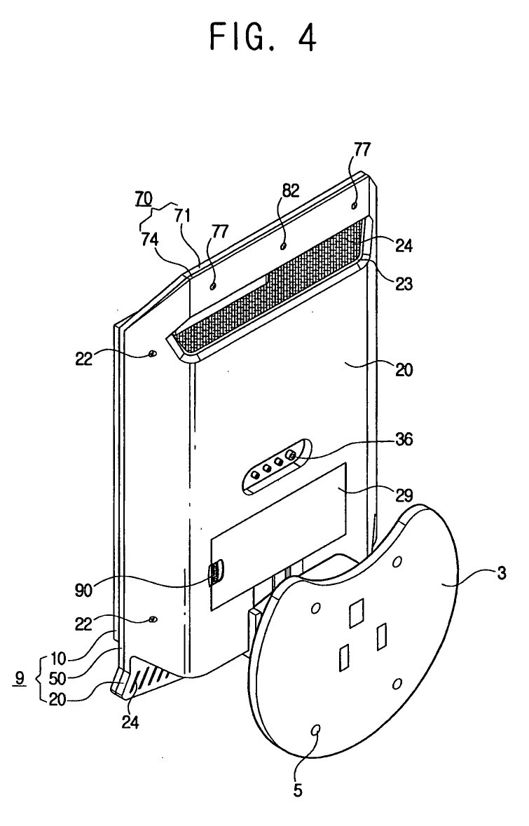

As shown in FIG. 1, a display apparatus can include a display main body 1 that can display a picture, a stand member 3 that can support the display main body 1, and a hinge 7 (FIG. 2) that can connect the display main body 1 and the stand member 3 to enable the display main body 1 to rotate relative to the stand member 3. Accordingly, the display main body 1 can rotate about the hinge 7, as shown in FIGS. 3 and 4.

The stand member 3 can be installed on a predetermined installation surface, such as a desk or a wall, and can function to support the display main body 1 by way of the hinge 7. Accordingly, the stand member 3 can be installed on a desk as shown in FIG. 3, or it can be installed on a wall, as shown in FIG. 4. FIG. 4 illustrates that the stand member 3 can be completely rotated relative to the display main body 1 by way of the hinge 7. It is an aspect that a plurality of installation holes 5 can be formed on a lower part of the stand member 3 for installation on the wall. Herein, the installation holes 5 can be formed according to a VESA standard.

The display main body 1 can include an LCD assembly 30 including a panel assembly that can display a picture and a main body 9 defining an exterior housing with an interior accommodation space. The LCD assembly 30 can be arranged at a front side of the main body 9. The main body 9 can include a front casing 10 coupled to the front of the LCD assembly 30, a rear casing 20 provided at a rear side of the LCD assembly 30 and coupled with the front casing 10, and a middle casing 50 provided between the LCD assembly 30 and the rear casing 20.

As shown FIG. 1, the front casing 10 can be formed with a front opening 11 in the middle of the front casing 10 to expose an LCD panel 31 of the LCD assembly 30 displaying the picture. On an inner side of the front casing 10 opposing the LCD assembly 30, a plurality of screw receiving bosses 12 to receive first screws 22 can be provided along a circumferential portion of the front opening 11 to couple together the front casing 10 and the rear casing 20. The screw receiving bosses 12 can include female screw-receiving arrangements.

The rear casing 20 can be formed with coupling holes 21 where the first screws 22 that thread into the screw receiving bosses 12 can be inserted. An upper area of the rear casing 20 can be formed with a first opening 23 that can have an oval shape to expose a discharging slit 63 of a discharging member 60. A lower area of the rear casing 20 can be formed with a plurality of air inflow slits 24 that allow entry of air into the display main body 1 to cool an inside of the display main body 1.

The rear casing 20 can be formed with a plurality of terminal through-holes 25 that can be spaced apart by a predetermined distance and can allow an input port 36 of a printed circuit board (PCB) assembly to pass through. Below the terminal through-holes 25 a battery installation part 26 can be provided that are depressed with respect to a surface of the rear casing 20 to allow the installation of a battery 29 to supply power to the display main body 1. The battery 29 may have a plurality of terminals to be connected to the LCD assembly 30 through the battery installation part 26.

The battery installation part 26 can have a rectangular shape corresponding to the shape of a battery 29 to thereby accommodate the battery 29. The depth of the battery installation part 26 can be depressed deep enough so as to prevent a surface of the inserted battery 29 from protruding from the surface of the rear casing 20. A first side of the battery installation part 26 can be formed with a locking hole 27 onto which a locking hook 28 formed on the battery 29 can lock and unlock. Because the locking hook 28 of the battery 29 can be connected with a manipulation knob 90 formed on the battery 29, the user can couple the battery 29 into or separate the battery 29 from the battery installation part 26 as the locking hook 28 of the battery 29 locks and unlocks with respect to the locking hole 27 of the battery installation part 26 by a manipulation of the manipulation knob 90.

The LCD assembly 30 can include the LCD panel 31 that can display the picture, an LCD supporting frame coupled to a circumferential area of the LCD panel 31, a printed circuit board (PCB) assembly that can transfer an electrical signal such as an image signal to the LCD panel 31, and a supporting member 33 that can support the LCD panel 31 and the PCB assembly.

The PCB assembly can include a PCB printed with wires and a plurality of components provided on the PCB. A first area of the PCB assembly can be provided with a plurality of input ports 36 that can pass through the terminal through-holes 25 of the rear casing 20 and can be exposed to an exterior to couple with a power input terminal and a cable connection terminal.

The supporting member 33 can include an LCD supporter 34 that can surround a circumferential area of the LCD supporting frame and can be coupled to the LCD panel 31, and a substrate accommodation part 35 that can be integrally formed with the LCD supporter 34 and can accommodate the PCB assembly. A first area of the substrate accommodation part 35 can be formed with a port through-hole 19 corresponding to the input port 36 of the PCB assembly.

Below the port through-hole 19, a connection member 44 can be provided to connect the LCD assembly 30 with the stand member 3. A first portion of the connection member 44 can be stably connected to the LCD supporter 34 and a second portion of the connection member 44 can be connected to the stand member 3 by way of the hinge 7 to enable the LCD supporter 34 to rotate relative to the stand member 3. Since a first coupling hole 41 formed on the LCD supporter 34 can be positioned below the port through-hole 19 and can be threaded with a second screw 42 passing through a second coupling hole 43 formed on the connection member 44, the connection member 44 can be connected to the LCD assembly 30.

The middle casing 50 can be arranged between the LCD assembly 30 and the rear casing 20. A top area of the middle casing 50 can be formed with a second opening 51 that can have an oval shape formed at a position corresponding to the first opening 23 of the rear casing 20. Also, a third opening 52 can be formed in the middle casing 50 to accommodate the substrate accommodation part 35 in a middle area of the middle casing 50, and can be spaced from the second opening 51 by a predetermined distance. The second opening 51 can be arranged so that the discharging member 60 is positioned between the middle casing 50 and the front casing 10.

On the middle casing 50, a plurality of coupling part through-holes 53 can be provided along a circumference of the third opening 52 to allow the screw receiving bosses 12, arranged on the circumference of the front casing 10 near the third opening 52, to pass through. The middle casing 50 can be formed with a pair of coupling bosses 54 that can accommodate boss accommodation parts 61 of the discharging member 60 in an area close to the second opening 51 to couple the middle casing 50 with the discharging member 60. The middle casing can also be formed with a pair of coupling protrusions 55 that can be positioned between the pair of coupling bosses 54, wherein each coupling protrusion 55 can be coupled to a protrusion insertion hole 62 formed on the discharging member 60.

The discharging member 60 can be secured in an area adjacent to the second opening 51 to position itself between the rear of the LCD assembly 30 and the middle casing 50. The discharging member 60 can include a plurality of discharging slits 63 formed thereon to expose the discharging member 60 to the exterior through the first opening 23 of the rear casing 20 to allow dissipation of heat generated in the display main body 1. The discharging member 60 can include the pair of boss accommodation parts 61 depressed at respective positions corresponding to the pair of coupling bosses 54 of the middle casing 50 to accommodate and couple with the coupling bosses 54 by way of third screws 65. The protrusion insertion holes 62 can be positioned between the pair of boss accommodation parts 61 and can be arranged to correspond with the coupling protrusions 55 of the middle casing 50 to allow coupling with the coupling protrusions 55.

A top area of the main body 9 can be provided with a handle 70 that can allow a user to stably carry the display apparatus without the user's grip slipping off of the handle 70.

The handle 70 can include a first handle part 71 extending upward from a top area of the middle casing 50 and positioned above a top side of the second opening 51. A second handle part 74 can be coupled to the first handle part 71 and can extend upward from the top area of the rear casing 20 and positioned above a top side of the first opening 23. An inner space of the handle 70 can be installed with a wireless antenna 80 of a PCB type that can be connected to the PCB assembly of th LCD assembly 30 to exchange a predetermined signal with the display main body 1. In other words, the inner space of the handle part 70, formed by the coupling of the first and second handle parts 71 and 74, can provide an empty area allowing the installation of the wireless antenna 80.

The first handle part 71 can be formed with a pair of first coupling bosses 72 to provide a coupling with the second handle part 74 and a second coupling boss 73 to couple the wireless antenna 80 between the first handle part 71 and the second handle part 74 and between the first pair of coupling bosses 72.

The second handle part 74 can be formed with a pair of first boss coupling holes 75 through which fourth screws 77, threadable into the first coupling bosses 72 of the first handle part 71, can pass through. The second handle part 74 can also be formed with a second boss coupling hole 76 that is arranged between the pair of first boss coupling holes 75. A fifth screw 82, that is threadable into the second coupling boss 73 of the first handle part 71, can pass through the second boss coupling hole 76. The fifth screw 82 can thread into the second coupling boss 73 as it passes through the second boss coupling hole 76 and an antenna through-hole 81 formed through the wireless antenna 80.

An assembly process of the display apparatus according to an embodiment of the general inventive concept will now be described below.

Firstly, the LCD assembly 30 can be assembled in advance and can be positioned on a rear surface of the front casing 10 so that the LCD panel 31 is exposed through the front opening 11 of the front casing 10 (refer to FIG. 2). As shown in FIG. 2, the input port 36 of the PCB assembly can be exposed to the exterior of the supporting member 33 through the port through-hole 19 of the substrate accommodation part 35. A lower part of the LCD assembly 30 can be connected to the connection member 44, and the connection member 44 can be connected to the stand member 3 by way of the hinge 7. The second screws 42 can be threaded into the first coupling holes 41 of the supporting member 33 by way of the second coupling holes 43 of the supporting member 44.

With the front casing 10 being coupled to the LCD assembly 30, the discharging member 60 can be secured to an area corresponding to the second opening 51 of the middle casing 50 so that the discharging member 60 is positioned between the front casing 10 and the middle casing 50. After the discharging member 60 is secured as described above, the middle casing 50 can be secured to the front casing 10. This can be achieved by inserting the coupling protrusions 55 of the middle casing 50 into the protrusion insertion holes 62 of the discharging member 60 and accommodating the coupling bosses 54 of the middle casing 50 into the boss accommodation parts 61 of the discharging member 60, and threading third screws 65 into the coupling bosses 54. Accordingly, the discharging member 60 can be secured to the area of the second opening 51 of the middle casing 50. In addition, in the state where the discharging member 60 is coupled to the area of the second opening 51 of the middle casing 50 as described above, the middle casing 50 can be coupled to the rear of the front casing 10 so that the discharging member 60 can be provided between the middle casing 50 and the front casing 10. As shown in FIG. 2, the substrate accommodation part 35 of the LCD assembly 30 can be accommodated in the third opening 52 of the middle casing 50, and the screw receiving bosses 12 of the front casing 10 can be inserted into the coupling part through-holes 53 formed in the middle casing 50.

The rear casing 20 can be secured to the rear side of the middle casing 50 so that the second opening 51 of the middle casing 50 and the first opening 23 of the rear casing 20 communicate with each other. In other words, each of the first screws 22, inserted into the respective coupling hole 21 of the rear casing 20, can be threaded into the respective screw receiving boss 12 of the front casing 10 after passing through the respective coupling part through-hole 53 of the middle casing 50.

To couple the first handle part 71 and the second handle part 74, the fourth screws 77 can be inserted into first boss holes 75 formed in the rear casing 20 and threaded into the first coupling bosses 72 of the middle casing 50. To install the wireless antenna 80 within the handle part 70, the fifth screw 82 can be inserted into the second boss coupling hole 76 of the rear casing 20 and can be threaded into the second coupling boss 73 of the middle casing 50. Accordingly, the handle 70 includes the first handle part 71 and the second handle part 74 including the opening 23, and can be provided on the upper part of the main body 9 of the display apparatus. Accordingly, a user can insert his/her fingers into the first opening 23 so that the display apparatus disclosed herein can be carried with a stable posture of the user since the handle 70 can be held with an entire part of the user's palm.

As described previously, in conventional display apparatus, it is highly likely that the fingers of a gripping hand may slip off of the handle groove provided by the conventional display apparatus, and the conventional display apparatus can therefore fall to the ground break during transport thereof because of an unstable position in which the user inserts his or her fingers into the handle groove. In contrast, the display apparatus according to the embodiments of the general inventive concept, a user can have a stable, secure grip on the handle part 70 of the display apparatus to carry the display apparatus easily without dropping it since the handle 70 is positioned above an opening in the upper part of the main body 9.

Furthermore, by providing the wireless antenna 80 in the handle part 70 positioned above the main body 9, a transmission and reception rate of wireless data of the wireless antenna 80 can be improved.

As described above, according to the embodiments of the general inventive concept, the display apparatus can be held in a stable position without being dropped.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A display apparatus, comprising:
a panel assembly capable of displaying a picture;
a main body supporting the panel assembly on a front side thereof and formed with an opening on an upper area thereof; and
a handle provided on a top area of the main body and positioned above the opening.

2. The display apparatus according to claim 1, wherein the handle extends upward from the top area of the main body and is arranged above the top side of the opening.

3. The display apparatus according to claim 2, wherein the main body comprises a front casing and a rear casing provided at the front and the rear of the panel assembly, respectively, and a middle casing provided between the panel assembly and the rear casing.

4. The display apparatus according to claim 3, wherein:
the opening comprises:
a first opening part formed at an upper part of the rear casing, and
a second opening part formed at an upper part of the middle casing; and
the handle comprises:
a first handle part extending upward from a top area of the middle casing and positioned above the second opening part, and
a second handle part coupled to the first handle part and extending upward from the top area of the rear casing and positioned above the first opening part.

5. The display apparatus according to claim 4, further comprising:
a discharging member provided between the front casing and the middle casing, the discharging member being capable of dissipating heat generated from an area inside the main body to an area outside the main body.

6. The display apparatus according to claim 1, wherein a wireless antenna capable of transmitting and receiving data is provided inside the handle.

7. The display apparatus according to claim 6, further comprising:
a battery; and
a battery installation part formed as a depression on a rear of the main body to accommodate the battery.

8. The display apparatus according to claim 7, further comprising:
a locking hole formed on a first side of the battery installation part; and
a locking hook provided on the battery and capable of locking with and releasing from the locking hole.

9. The display apparatus according to claim 2, wherein a wireless antenna capable of transmitting and receiving data is provided inside the handle.

10. The display apparatus according to claim 9, further comprising:
a battery; and
a battery installation part formed as a depression on a rear of the main body to accommodate the battery.

11. The display apparatus according to claim 10, further comprising:
a locking hole formed on a first side of the battery installation part; and
a locking hook provided on the battery and capable of locking with and releasing from the locking hole.

12. The display apparatus according to claim 3, wherein a wireless antenna capable of transmitting and receiving data is provided inside the handle.

13. The display apparatus according to claim 12, further comprising:
a battery; and
a battery installation part formed as a depression on a rear of the main body to accommodate the battery.

14. The display apparatus according to claim 13, further comprising:
a locking hole formed on a first side of the battery installation part; and
a locking hook provided on the battery and capable of locking with and releasing from the locking hole.

15. The display apparatus according to claim 4, wherein a wireless antenna capable of transmitting and receiving data is provided inside the handle part.

16. The display apparatus according to claim 15, further comprising:
a battery; and
a battery installation part formed as a depression on a rear of the main body to accommodate the battery.

17. The display apparatus according to claim 16, further comprising:
a locking hole formed on a first side of the battery installation part; and
a locking hook provided on the battery and capable of locking with and releasing from the locking hole.

18. The display apparatus according to claim 5, wherein a wireless antenna capable of transmitting and receiving data is provided inside the handle part.

19. The display apparatus according to claim 18, further comprising:
a battery; and
a battery installation part formed as a depression on a rear of the main body to accommodate the battery.

20. The display apparatus according to claim 19, further comprising:
a locking hole formed on a first side of the battery installation part; and
a locking hook provided on the battery and capable of locking with and releasing from the locking hole.

21. A display apparatus comprising:
a flat panel display assembly including a flat panel display capable of displaying an image; and
a main housing body arranged to support the flat panel display assembly and including a carrying handle structure extending above the main housing and forming an opening with the main housing.

22. The display apparatus of claim 21, wherein the carrying handle structure is positioned substantially above a center of gravity of the flat panel display.

23. The display apparatus of claim 21, wherein the main housing body includes a front casing operatively arranged with the flat panel display assembly, a rear casing, and a middle casing arranged between the front casing and the rear casing.

24. The display apparatus of claim 23, wherein the carrying handle structure includes a first handle part extending upwardly from a top side of the middle casing and a second handle part extending upwardly from a top side of the rear casing.

25. The display apparatus of claim 24, wherein the second handle part partially defines a first opening in the rear casing and the first handle part partially defines a second opening in the middle casing.

26. The display apparatus of claim 25, wherein the middle casing and the rear casing are securely attached to one another such that the first opening of the rear casing and the second opening of the middle casing are substantially coaxial to form a finger receiving area of the carrying handle structure.

27. The display apparatus of claim 25, further comprising a heat dissipating member provided between the front casing and the middle casing and arranged to direct heat from an interior of the main housing body to an exterior thereof through the first and second openings.

28. The display apparatus of claim 24, further comprising a wireless antenna arranged between the first handle part and the second handle part.

29. The display apparatus of claim 24, further comprising a battery installation depression formed in the rear casing, the battery installation depression being shaped to accommodate a battery to power the display apparatus.

30. The display apparatus of claim 21, further comprising a stand member pivotally connected to the main housing body by a hinge.

31. The display apparatus of claim 23, wherein flat panel display includes a printed circuit board assembly including an input port facing towards a rear portion of the flat panel display, and the rear casing comprises a plurality of terminal through-holes that are spaced apart by a predetermined distance to allow the input port of the printed circuit board assembly to pass through.

32. A method of making a display apparatus comprising:
securing a flat panel display assembly to a front casing;
securing a stand member to the flat panel display assembly;
securing a middle casing including a first handle part arranged on a top part thereof to the front casing; and
securing a rear casing including a second handle part arranged on a top part thereof to the middle casing such that the first handle part and the second handle part form a carrying handle structure to allow carrying of the display apparatus.

33. The method of claim 32, wherein securing the middle casing to the front casing includes arranging a heat dissipating member between the front casing and the middle casing to dissipate heat.

34. The method of claim 33, wherein securing the middle casing to the front casing includes accommodating a portion of the flat panel display assembly in an opening formed in the middle casing.

35. The method of claim 34, wherein securing the rear casing to the middle casing includes aligning openings formed below each of the first handle part and the second handle part to form the carrying handle structure.

36. The method of claim 32, wherein securing the rear casing to the middle casing includes securing a wireless antenna between the first handle part of the middle casing and the second handle part of the rear casing.

37. A display apparatus comprising:
a display main body having a flat panel display assembly to display an image;
a handle formed on a first portion of the display main body; and
a stand member rotatably coupled to a second portion of the display main body.

38. The display apparatus of claim 37, wherein the handle comprises an antenna disposed therein to communicate with the flat panel display assembly.

39. The display apparatus of claim 37, wherein the first portion is opposite to the second portion with respect to the flat panel display assembly.
